(19) United States
(12) Patent Application Publication
(10) Pub. No.: US 2024/0078323 A1
(43) Pub. Date: Mar. 7, 2024

(54) COUNTER TREE

(71) Applicant: Arm Limited, Cambridge (GB)

(72) Inventors: Alexander Klimov, Hadera (IL); Andreas Lars Sandberg, Cambridge (GB); Roberto Avanzi, Munich (DE)

(73) Assignee: Arm Limited, Cambridge (GB)

(21) Appl. No.: 18/446,528

(22) Filed: Aug. 9, 2023

(30) Foreign Application Priority Data
Sep. 1, 2022 (GB) 2212714.6

(51) Int. Cl. G06F 21/60; G06F 21/74

(52) U.S. Cl. CPC G06F 21/602; G06F 21/74

(57) ABSTRACT

An apparatus comprises counter tree circuitry configured to store, in a first node of a counter tree, a representation of a parent counter value and in a second node of the counter tree, wherein the second node is a child node of the first node, an encrypted representation of two or more counter values. The encryption operation for forming the encrypted representation of the two or more counter values takes as an input the parent counter value. The apparatus also comprises integrity checking circuitry to check the integrity of an item of data retrieved from memory based on a comparison between a stored authentication code and a generated authentication code generated based on the item of data and a decrypted counter value determined from an encrypted representation of a counter value retrieved from the second node, decrypted using a parent counter value retrieved from the first node.

The present technique relates to the field of data processing.

Some data processing systems may need to store large amounts of data. Providing enough capacity to store all such data in a memory which cannot be tampered with by an attacker may be infeasible, and so sometimes it may be necessary to export some sensitive information to a memory which is vulnerable to attack. For example, while data stored in trusted memory may be secured against attacks, trusted, or on-chip, memory storage may be limited and so it may be required to write data to a non-trusted, such as external, or off-chip, memory. An attacker may be able to read data from the external memory or intercept the data as it is passed to the external memory, and/or tamper with data values stored in the external memory in an attempt to cause incorrect behaviour when such externally stored data is subsequently brought back into the processing system. It is desirable to check the integrity of data stored in non-trusted memory to identify when the data has been modified since it was stored to memory. It is also desirable for the overhead associated with checking the integrity of data to be reduced.

At least some examples provide an apparatus comprising:
counter tree circuitry configured to maintain a counter tree comprising a plurality of nodes;
wherein the counter tree circuitry is configured to store:
   in a first node of the counter tree, a representation of a parent counter value; and
   in a second node of the counter tree, wherein the second node is a child node of the first node, an encrypted representation of two or more counter values, wherein an encryption operation for forming the encrypted representation of the two or more counter values takes as an input the parent counter value; and
integrity checking circuitry configured to check the integrity of an item of data retrieved from memory based on a comparison between a stored authentication code and a generated authentication code generated based on the item of data and a decrypted counter value, the decrypted counter value being determined from a corresponding retrieved encrypted representation of a counter value retrieved from the second node,
wherein the retrieved encrypted representation of the counter value is decrypted using a retrieved parent counter value retrieved from the first node.

At least some examples provide a method of operating a data processing apparatus to maintain integrity of data, comprising:
maintaining a counter tree comprising a plurality of nodes;
storing, in a first node of the counter tree, a representation of a parent counter value;
storing, in a second node of the counter tree, wherein the second node is a child node of the first node, an encrypted representation of two or more counter values, wherein an encryption operation for forming the encrypted representation of the two or more counter values takes as an input the parent counter value; and
checking the integrity of an item of data retrieved from memory based on a comparison between a stored authentication code and a generated authentication code generated based on the item of data and a decrypted counter value, the decrypted counter value being determined from a corresponding retrieved encrypted representation of a counter value retrieved from the second node,
wherein the retrieved encrypted representation of the counter value is decrypted using a retrieved parent counter value retrieved from the first node.

At least some examples provide a computer program for controlling a host data processing apparatus to provide an instruction execution environment, comprising:
counter tree program logic to maintain a counter tree comprising a plurality of nodes;
wherein the counter tree program logic is arranged to store:
   in a first node of the counter tree, a representation of a parent counter value; and
   in a second node of the counter tree, wherein the second node is a child node of the first node, an encrypted representation of two or more counter values, wherein an encryption operation for forming the encrypted representation of the two or more counter values takes as an input the parent counter value; and
integrity checking program logic to check the integrity of an item of data retrieved from memory based on a comparison between a stored authentication code and a generated authentication code generated based on the item of data and a decrypted counter value, the decrypted counter value being determined from a corresponding retrieved encrypted representation of a counter value retrieved from the second node,
wherein the retrieved encrypted representation of the counter value is decrypted using a retrieved parent counter value retrieved from the first node.

The computer program may be stored on a storage medium. The storage medium may be a non-transitory medium.

Further aspects, features and advantages of the present technique will be apparent from the following description of examples, which is to be read in conjunction with the accompanying drawings, in which:

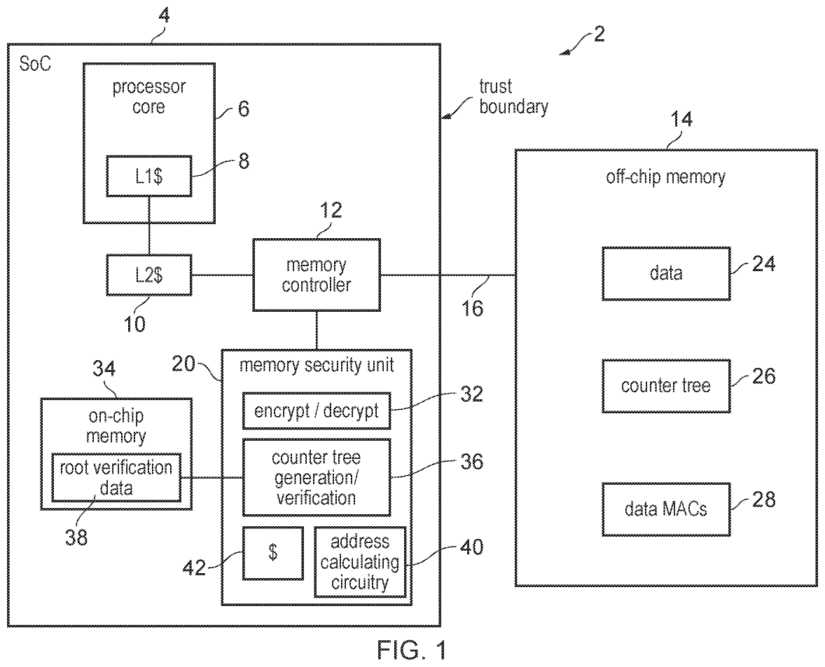

FIG. 1 schematically illustrates an example of a data processing system.

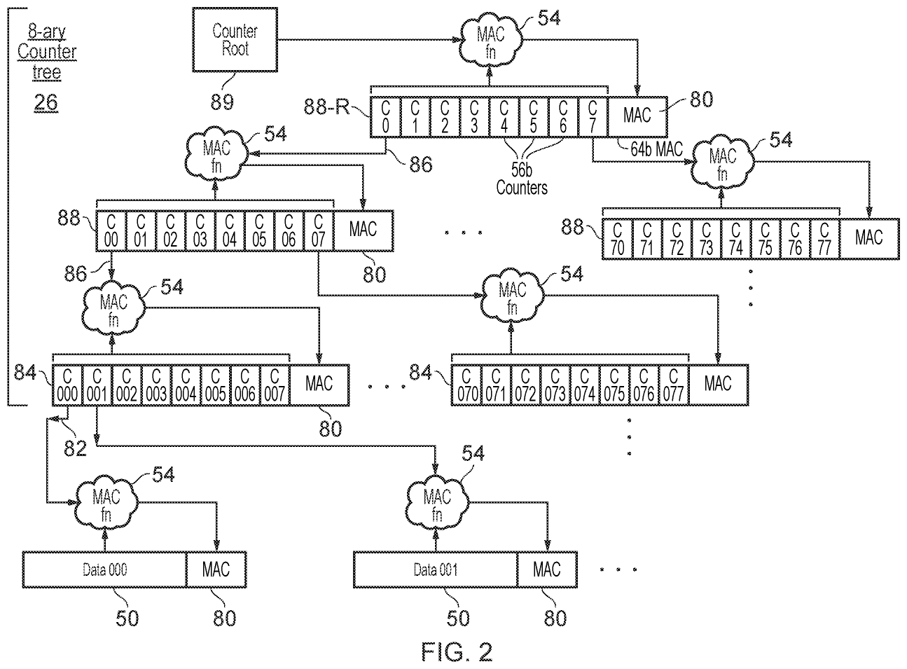

FIG. 2 schematically illustrates a data integrity tree.

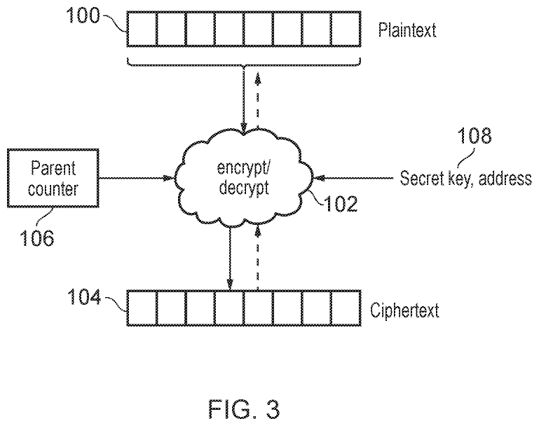

FIG. 3 schematically illustrates an example of an encryption operation.

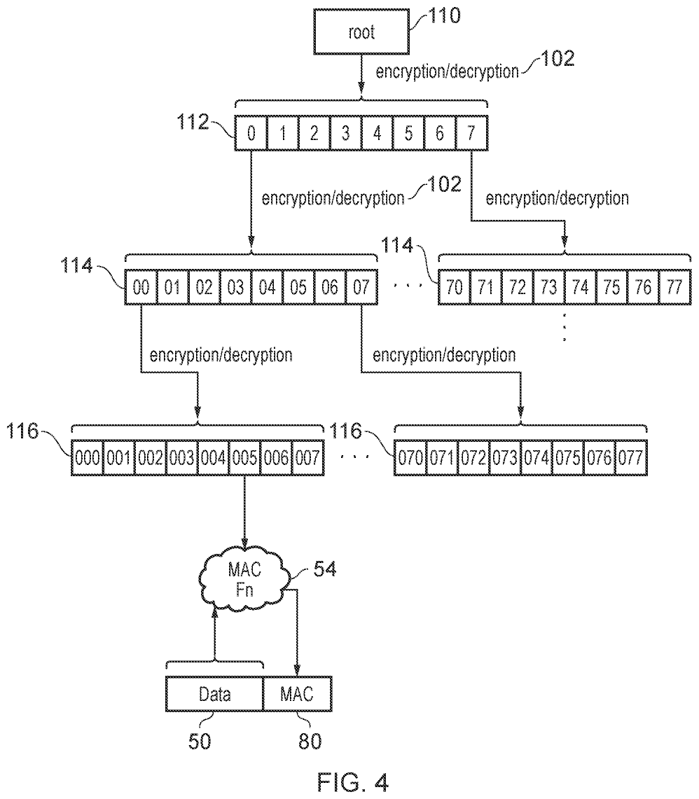

FIG. 4 schematically illustrates an example of a counter tree.

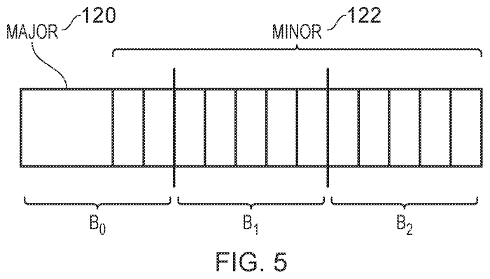

FIG. 5 illustrates an example of a node of a counter tree having split counters.

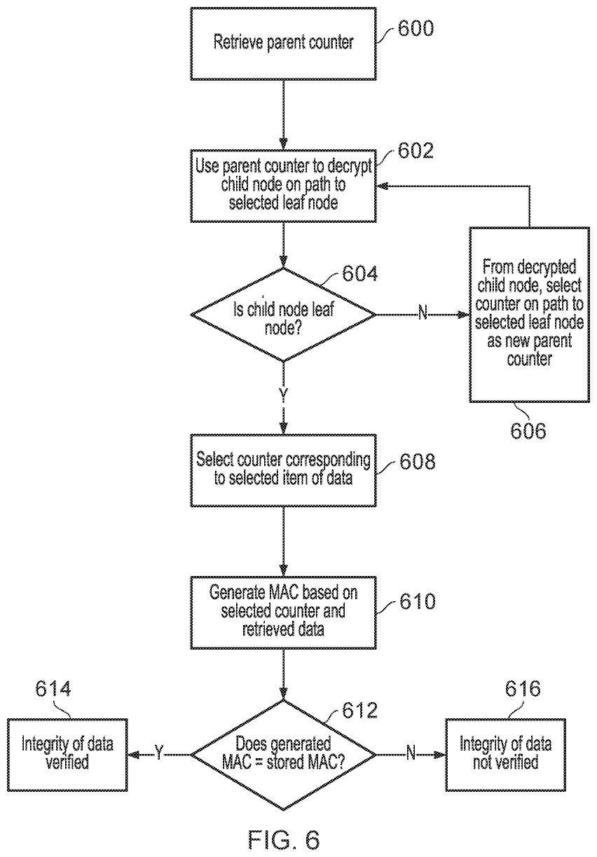

FIG. 6 is a flow diagram illustrating a method of using a counter tree to protect the integrity of an item of data.

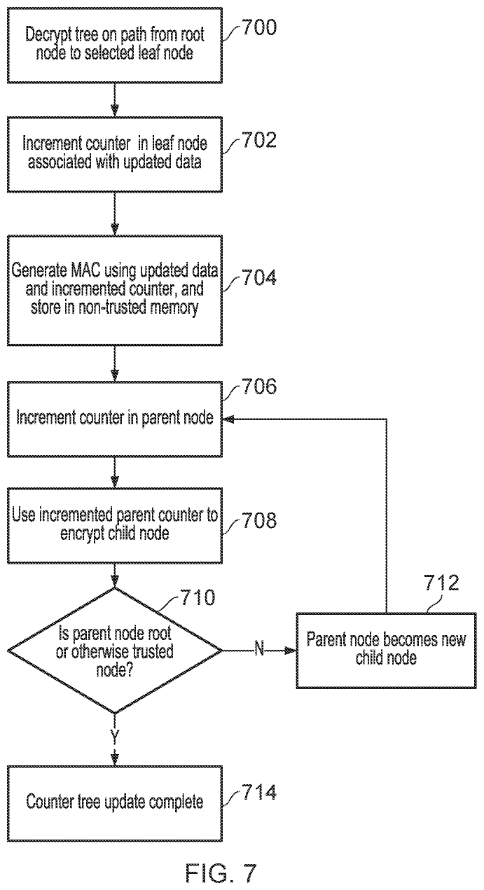

FIG. 7 is a flow diagram illustrating a method of updating a counter tree when storing an item of data to memory.

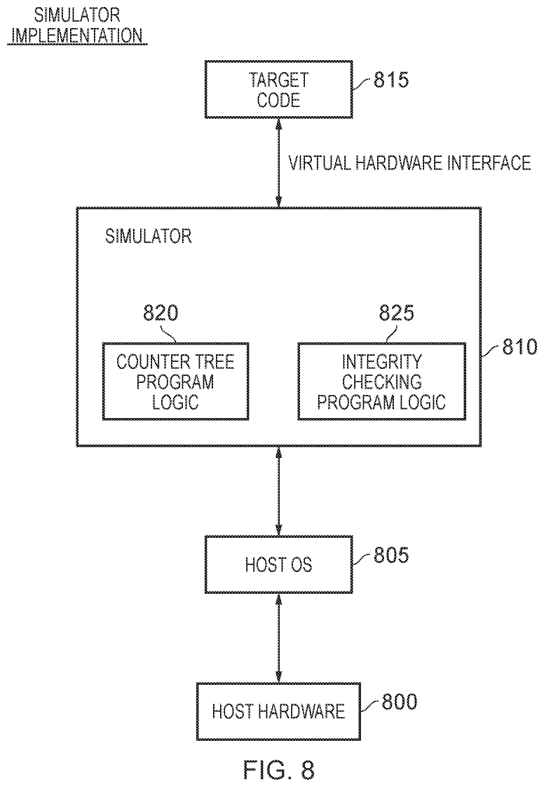

FIG. 8 schematically illustrates a simulator implementation.

A data processing apparatus comprises integrity checking circuitry to check the integrity of an item of data stored in a protected memory region of non-trusted memory. For example, the integrity verification may be for detecting an attacker tampering with the data stored in the protected memory region. For example, the memory could be an off-chip memory on a separate integrated circuit from the integrated circuit comprising the memory access circuitry. It will be appreciated that non-trusted memory may have some level of trust, and may alternatively be referred to as less-trusted memory, trusted less than another region of memory such as on-chip memory.

When writing an item of data to the memory, the integrity checking circuitry may generate an authentication code based on the item of data. The authentication code may be stored in the memory along with the item of data to be protected, where the memory may be non-trusted memory. When retrieving the item of data from memory, the integrity checking circuitry compares the stored authentication code with an authentication code generated based on the retrieved data. If the stored and generated authentication codes match, then it may be determined that the item of data has not been modified between being stored and being retrieved. The authentication codes are also generated based on a counter (in addition to being based on the item of data to be protected), which may be updated when the item of data is stored to memory. The counter prevents replay attacks by ensuring that a set of data and authentication code cannot be replaced in memory with a previously valid set of data and authentication code (which would otherwise pass the integrity verification checks), as the counter may have changed since the previous set of data and authentication code were valid meaning that the generated authentication code will be generated in a different way to the stored authentication code, and hence will not match. Each item of data in the address range protected by the integrity checking circuitry may be associated with a different counter, meaning that there may be a significant amount of storage space needed to store all of the counters. Often the capacity to hold data in a storage unit which is not vulnerable to an attacker, such as an on-chip memory on the same integrated circuit as the memory access circuitry, may be limited. Hence, in practice it may be required to store at least part of the set of counters to the same memory as storing the data to be protected. This may make the counters vulnerable to an attack.

In one example technique, the counters are themselves subject to integrity verification when they are read, in a similar way to the actual data of interest, based on further authentication codes which may also be stored in the memory. To manage a series of integrity checks for the data of interest and each piece of information required for verifying the data, some examples represent the information as an integrity tree comprising a number of nodes, where a root node can be used to verify a number of branch nodes that are child nodes of the root node, each of those branch nodes can then be used to verify further branch nodes which are child nodes of those earlier branch nodes, and so on until leaf nodes are reached which can be used for verification of a corresponding address block of data (item of data) stored in the memory. In a tree structure, two nodes may be in a parent-child relationship when one of the nodes (the parent node) contains information corresponding to the other (the child node) and where the parent node is closer to a root node and the child node is closer to a leaf node. It will be appreciated that the use of the term “closer” refers to the position of a node in a counter tree, and does not imply anything about the position that the nodes are stored in memory. Each node may store a number of counters used to verify corresponding items of data or child nodes and an authentication code (also referred to as a message authentication code, MAC) used to verify that node. There is no requirement for the counters of a node and the MAC to be stored together in memory, although in some examples they may be stored together, such as in the same cache line. Each node comprising several counters can be verified using a single counter stored in the parent node, and hence the storage requirements each level of the tree decrease further up the tree until there are few enough counters to be stored in a trusted memory (or protected using a MAC stored in trusted memory). Hence, the values stored in a trusted memory can be used to verify values stored in a first level of nodes of the tree, which can be used to verify values in a second level of nodes, and so on until the entire tree can be verified. However, in this example the authentication code associated with each node may require a significant amount of storage space. In one example storing counters in a 64-byte block, 64 bits may be spent on the MAC, meaning that ⅛ of the memory consumed by the tree is used for the MAC. If the technique did not require a MAC, either: the bits used to store the MAC could be removed reducing the storage requirements of the tree, or the storage previously used for the MAC could instead be used to store additional counters and the arity of the tree could be increased, reducing the height of a tree and therefore reducing the overhead of traversing the tree. Hence, it would be desirable to protect the integrity of data in non-trusted memory without using MACs in a tree. In addition, the integrity verification process for verifying each node may be computationally intensive, and it may be desirable to reduce the power cost of the apparatus by enabling these operations to be removed.

In examples of the present technique, the apparatus comprises counter tree circuitry configured to maintain a counter tree comprising a plurality of nodes. The structure of the counter tree may be substantially the same as the tree discussed above, except nodes at each level may not be used to verify nodes at another level of the tree. The counter tree circuitry is configured to store, in a first node of the counter tree, a representation of a parent counter value. The counter tree circuitry is also configured to store, in a second node of the counter tree which is a child node of the first node, an encrypted representation of two or more counter values, wherein an encryption operation for forming the encrypted representation of the two or more counter values takes as an input the parent counter value. Hence, the counters in the second node are encrypted based on the counter in their parent node, the first node. The encryption operation may also take other values as inputs, such as a secret key or an address of a node to be encrypted.

When checking the integrity of an item of data retrieved from memory, the integrity checking circuitry generates the authentication code based on a counter that has been retrieved from the leaf node of the counter tree (a second node) that corresponds to said data item. The retrieved counter is decrypted using a parent counter value retrieved from the parent node of the second node (having previously been encrypted using the parent counter value). In some examples the parent counter value may be encrypted when stored in the first node to form the representation of the parent counter value. Therefore, in some examples, retrieving the parent counter value from the parent node may include decrypting the representation of the parent counter value.

If an attacker wishes to replace some data stored in memory with some other data without this change being identified by the integrity checking circuitry, they may attempt to perform a replay attack. A replay attack uses previously valid data as observed on the bus or read from non-trusted memory to replace the currently stored values. The counter is intended to prevent replay attacks, being incremented each time new data is stored to memory and used in the MAC function such that the relationship between data and MAC changes over time. Therefore, a previously valid combination of data and MAC may no longer be valid when used in a replay attack. However, an attacker may wish to also replace the counter value with a previous counter value to bypass this replay attack prevention mechanism. In the tree storing authentication codes at each node as discussed above this is prevented by checking the integrity of the counter. In examples of the present technique, replacing the counter with a previous value may be caused to fail by encrypting the counter value depending on a parent counter value in a higher-level node. The parent counter value in the higher-level node may be incremented each time the counter value is updated (each time the data is updated), meaning that the relationship between decrypted and encrypted versions of the counter changes over time. Hence, if an attacker replaces the ciphertext of the counter with a previous version, this will be decrypted in a different way to when it was previously used. Hence, the previously observed encrypted counter value does not produce a decrypted counter value that allows the replayed data and MAC to pass the integrity check.

Hence, encrypting a node using a value stored in its parent node can increase resistance against replay attacks for a stored item of data without requiring that the integrity of the tree is verified. As the counters are not verified at each level of the counter tree, there may be no requirement to store authentication codes in the counter tree (although some examples may store authentication codes, discussed below) meaning that each node may be made smaller to reduce the storage requirements of the counter tree, or be made to include more counters, increasing the arity and reducing the height of the counter tree.

In some examples, the second node storing the two or more counters stores the counters independently from each other. For example, a decrypted representation of the node may comprise a number of bits separated into sections wherein each section corresponds to a single independent counter. However, certain bits of the counters (such as the most significant bits) may often be the same between several counters of the node. For example, if all counters start at 0, the most significant bits of every counter will start with the same value. Representing the same bits in each separate counter may therefore be an inefficient use of storage. An alternative is to use split counters, in which each counter comprises the combination of a major counter and a minor counter. A given counter may be provided by the combination of the major counter and a minor counter. The major and minor counter may be combined by concatenation or addition, for example. In some examples, the bits of the major counter may represent the most significant bits of the counter and the bits of the minor counter may represent the remaining bits of the counter. The major counter can be shared between several minor counters, meaning that on average each counter can be represented in fewer bits, reducing the storage requirement of each counter.

As discussed above, encrypting a node using a value in the parent node means that replay attacks are not expected to succeed. Therefore, from the perspective of the attacker, any previously unseen ciphertext is as good as any other when modifying the encrypted representation of the counter in an attack. Only one value of the counter may produce the correct MAC, meaning that the chance of success decreases as the size of the counter increases. For example, with a 64-bit counter the probability of a successful attack may be the probability that the counter will randomly match, which is 2\hat{ }{−64}.

Certain encryption algorithms (known as block ciphers) operate at a fixed block size, meaning that the number of bits of plaintext that can be encrypted in one iteration of the encryption algorithm may be fixed. For example, the AES block cipher can encrypt 128 bits of plaintext to produce 128 bits of ciphertext in one iteration. If an item of plaintext is to be encrypted using a block cipher when the block size is smaller than the size of the item of data, the item of data may be separated into sections and each section may be encrypted separately.

In some examples a node may be encrypted using a block cipher having a block size smaller than the node. In some of these examples, the node may store the two or more counter values as split counters. This may mean that the major counter is encrypted in one block and certain minor counters are encrypted in a separate block. As described above, an attacker may wish to replace the counter so that it generates the correct MAC for an item of data. In some examples, they may wish to only modify a few bits of the counter leaving the majority of the counter the same (e.g., if rolling back to a previous set of data and MAC). For example, the attacker may wish to leave the bits of the counter corresponding to the major counter unchanged. If the counters are encrypted in blocks with the major counter in a different block to the minor counter, the attacker may simply leave the ciphertext of the block corresponding to the major counter unchanged and modify the ciphertext of the block containing the minor counter. To perform a successful attack in these cases, the attacker only needs to correctly guess the bits of the minor counter because the bits of the major counter are unchanged, meaning that in this case the attacker has a much greater chance of success than if they had to guess all bits of the counter. For example, if a minor counter uses 8 bits of storage, the attacker could have a 2\hat{ }{−8} chance of success.

To solve the problem described above in which the use of split counters encrypted in separate blocks leads to an increased probability of a successful attack, in some examples of the technique the encryption operation for forming the encrypted representation of the two or more counter values may be a full-node encryption operation which encrypts all of the two or more counters in a single encryption block.

This may be achieved in more than one way. For example, the counter tree circuitry may restrict the number and/or size of counters that can be stored in a given node such that the size of a given node is equal to or less than the block size of a selected block cipher. If AES were selected as a block cipher, the counter tree could be restricted such that each node has 128 bits or fewer, for example. This could ensure that the major and minor counters are encrypted together (and hence remove the possibility of modifying a minor counter without modifying a corresponding major counter), but may limit the arity of the tree, leading to greater tree height and increased overhead associated with traversing the counter tree. In another example, the number of bits encrypted together in one encryption operation could be increased beyond the block size of a typical block cipher, and the major and minor counters could therefore be encrypted together. Increasing the size of one encryption operation (as opposed to reducing the size of a node) may be achieved with a wide-block encryption technique. It will be appreciated that each encryption operation described above takes as an input a parent counter value.

In some examples, full-node encryption may not be used. Instead, the counter tree circuitry may be configured to use an encryption operation for forming the encrypted representation of the two or more counter values which encrypts a block containing major counters (which may also contain minor counters) based on the two or more corresponding minor counters stored in other blocks of the node. The corresponding decryption operation may then use the retrieved minor counters to decrypt the retrieved major block. By encrypting the major counter based on the minor counters, modification of the minor counters will cause the major block to be decrypted differently. Therefore, the minor blocks cannot be modified whilst leaving the plaintext of the major block unchanged, because the ciphertext of the major block will be decrypted depending on the minor blocks, so modifications to the minor blocks will modify the way the major block is decrypted. In this way the encryption of a split-counter node can be performed using a block cipher whilst reducing the probability of a successful attack. Compared to the use of block-sized nodes, this enables nodes to be much larger which can improve the arity of the tree. Compared to wide-block encryption, this avoids the high overhead associated with wide-block encryption techniques.

There are several ways the block containing the major counter can be encrypted depending on the minor counters. The node may comprise blocks B₀ to B_{N}, in which each block is selected to have the same number of bits as the block-size of the selected block cipher. Block B₀ may comprise the major counter, and optionally one or more minor counters. Blocks B₁ to B_{N} may comprise only minor counters. The encryption operation for encrypting block B₀ could take as an input (sometimes referred to as a tweak) at least a subset of the bits of the blocks B₁ to B_{N} (in addition to the parent counter value).

In one example, the tweaks are combined to form a value, which may be labelled X. This may take the form X=H(A∥C^{P}∥B₁∥ . . . ∥B_{N}), where H is a block-wide universal hash function (UHF), ∥ is the concatenation operation, A is an address of the node (discussed in further detail below), and B₁ to B_{N} includes each minor block containing minor counters associated with the major counter in block B₀. It will be appreciated that the particular order of the operands, the manner in which they are combined, the number of tweaks (additional tweaks could be included), and the form of the UHF are not necessarily restricted, and equivalent functions can be used to combine the tweaks using a block-wide technique.

The blocks which only contain minor counters may be stored to memory without being encrypted at all (each counter will still be encrypted because each counter includes bits in the major block, which will be encrypted) or could be hashed, for example. Encryption of the minor blocks is not necessary for security given that encryption of the major block depends on the minor counters. If a minor counter is modified, the decryption of the major block will fail to give correct results.

The block containing the major counter (the major block) could be encrypted using the value X to create the encrypted major block D₀ in the function D₀=E(B₀)⊕X, wherein E is an encryption operation (such as a block cipher) and ⊕ is the XOR operation. In this way, the block B₀ is encrypted such that the ciphertext of the major block depends on the minor counters. However, the function D₀=E(B₀)⊕X (encrypt-xor) may leak the effects of the UHF (which may be linear), thus allowing an attacker to take and modify ciphertext at one address to spoof ciphertext at another.

In an alternative technique, the function D₀=E(B₀⊕X) may be used to provide the ciphertext for the major block. This function (xor-encrypt) would appear to be safer than encrypt-xor because it may only leak the effects of the UHF in the case of a collision (i.e., when two different sets of inputs produce the same encrypted output). For example, when E(B′₀⊕X′)=E(B″₀⊕X″) it can be deduced that B′₀ ⊕X′=B″₀⊕X″. Collisions may be rare with large counter sizes (2\hat{ }64 evaluations may be required for a collision with a 64-bit counter), and the probability of a successful active attack (taking some known ciphertext and tweaking parameters of H) is also low (the probability that the counter will randomly match).

In a further technique, the function D₀=E(X⊕B₀)⊕X could be used to provide the ciphertext for the major block. This is an example of a xor-encrypt-xor (XEX) construction. XEX may be safer than the alternatives described above.

In some examples (mentioned above) the encryption operation for forming the encrypted representation of the two or more counter values may take as an input an index of the second node. In this way, the relationship between plaintext and ciphertext can be made different for each node. Hence, when an index of a node is used as a tweak in the encryption operation, an attack which attempts to swap blocks of counters between nodes is not expected to succeed. The index is not particularly limited. In some examples, the index may be a value which is unique to each node in the counter tree.

However, in some examples, the index is derived from the memory address of the second node. The index may be a subset of the bits of the memory address of the node, for example. This is an effective way of providing an index that is unique per node, as it does not need to be stored.

In some examples, the second node is stored in non-trusted memory. In some examples, the first node which is a parent node of the second node is also stored in non-trusted memory. Hence, whilst the parent counter value stored in the first node may be used to protect the second node (by ensuring it cannot be modified without being incorrectly decrypted), the parent counter itself could be vulnerable to modification.

In some examples, the integrity of the first node may be verified before the parent counter value is used to decrypt the second node. For example, the first node and higher-level nodes may include MACs to verify the nodes. The levels of the tree above the first node may be verified in dependence on a protected root value (e.g., the root value protects the child nodes of the root node, which in turn protect their child nodes and so on). Hence, modification of the parent counter value could be identified by performing integrity checking on the first node in dependence on a protected root value. However, whilst this technique enables MACs to be removed from the second nodes (the leaf nodes of the tree), it does not necessarily enable MACs to be removed from the entire tree, and additionally it increases the overhead associated with retrieving each node, because certain nodes would be verified.

In some examples, there is a further layer of the counter tree provided above the first node. The values stored in the first node (which may be two or more parent counter values including the parent counter value for the second node) may themselves be encrypted in a second encryption operation. The second encryption may take as an input a further counter value associated with a further node which is a parent node of the first node.

The integrity checking circuitry may be configured to decrypt the encrypted representation of the parent counter (or the two or more parent counters) using a retrieved value retrieved from the further node. Because the parent counter is decrypted in dependence on a further value in a higher-level node, the attacker may not be able to replace the ciphertext of the parent counter with previously observed parent counter ciphertext, because since the previous ciphertext was observed its own parent counter is expected to have been incremented. Hence, the parent counter would be decrypted differently from when it was previously used.

In some examples, each node of the tree is encrypted based on a value stored in a parent node. At the top of the tree there may be a protected root node storing a value which can be trusted to have not been modified. This can be provided in several ways as discussed later.

The root node may store two or more counters, each corresponding to one child node. The counter corresponding to each child node may be used in the encryption operation for encrypting that child node. Each child node of the root node may then store two or more counters each corresponding to a child node in a further level of the tree, used to encrypt said child node in the further level. This pattern may extend all the way to the bottom of the tree where the first node stores a parent counter value used to encrypt the second node (a leaf node) and the second node stores a counter value used in integrity verification.

If an attacker modifies an item of data protected by the tree, then the MAC generated based on the modified item of data will not match the stored MAC. If the attacker modifies both the data and the stored MAC (for example using a previously valid pair) then the generated MAC will not match the stored MAC because the MAC generation process takes as an input a counter which is expected to have changed since the previously valid pair was observed. If an attacker modifies the data, the stored MAC, and the counter (using previously valid values), then this will be identified because the counter is encrypted and the decryption operation depends on a further counter. Using an old encrypted (ciphertext) counter value may not lead to the same decrypted counter (plaintext) because the further counter may have been updated and therefore may be different from the further counter that was used to encrypt the old encrypted counter value. This argument can be repeated up the tree until the root node is reached. An attacker may need to replace every counter on the path from the root node to the second node in order to use previously observed counter values to modify data, but they cannot modify the root node (without it being detected) and therefore an attacker cannot replace counters with previously valid values. Therefore, the counter tree reduces the likelihood of an attacker successfully modifying data without being identified by the integrity circuitry. The only attack an attacker may have is to randomly guess which counter value will give the correct result at a given level, and with sufficiently large counters this attack can be made infeasible.

Providing a counter tree in which a node is encrypted based on a counter stored at a higher level allows a counter tree to be used to protect data integrity without requiring each node to be protected by a MAC. A MAC may still be used to protect an item of data, but is not required to protect the counters themselves. Any modification to the counters may simply cause the lower levels of the counter tree to be decrypted incorrectly, leading to an incorrect counter being decrypted from the second node and the incorrect generation of a MAC in the data integrity check. Hence, the bits that may otherwise be used to store a MAC in each node may be removed from each node, reducing the storage cost of providing the counter tree. Alternatively, the bits that may otherwise be used to store a MAC could be used to store additional counters. With more counters per node, the tree can “fan out” quicker (the tree can have increased arity) meaning that fewer levels of the tree may be provided to store the same number of nodes. This means that a given path from the root node to a given leaf node may have fewer nodes, so that the traversal of the tree may require fewer memory accesses and tree operations. Increased arity may therefore cause the overhead of accessing the tree to be reduced. Hence, removing MACs from a tree can be associated with several advantages. In some examples, MACs may be provided in a number of higher-level nodes to verify a number of lower nodes, and the nodes at the lower level and below may then be used to decrypt their child nodes, providing a hybrid between a MAC tree and a tree using node decryption which would benefit from some of the advantages of removing MACs.

In some cases the second node (and optionally other nodes at the same level as the second node) may be the only node without a MAC. In other examples, each node of the tree may be encrypted using a counter stored in a parent node, and therefore each node may be provided without a MAC.

In some examples, a counter is updated each time the corresponding item of data in memory is updated, so that the previous data and MAC combination becomes invalid. In some examples the counter may be updated less frequently, such as every other time the data is updated but this may be significantly less secure against replay attacks. In some examples, the parent counter value is likewise updated every time a counter value in its corresponding child node is updated. This may extend up the tree, such that each counter on a path from the root node to an item of data is updated each time the item of data is updated, in order to prevent previous counters being used in a replay attack.

In some examples the authentication code generated during data integrity checking is generated based on additional values in addition to the item of data and a parent counter. For instance, the algorithm for forming the authentication code may also take as an input a secret key. The use of a secret key obfuscates the association between the stored data and the generated MAC, which may make an attack more difficult. The authentication code may also, for example, be generated based on an index of a memory location at which the item of data is stored, such as the address of the memory location or a subset of the bits of the address. The use of an index in the generation of a MAC makes the combination of data and MAC unique to a particular memory location, which may also make an attack more difficult.

The root node of the counter tree is the node at the top of the tree which is associated with each leaf node of the tree. A traversal of the tree will include the root node. A value stored in the root node may be associated with a single child node (which then contains values for several child nodes) or may be associated with several child nodes, depending on the tree. A value stored in a root node may be used to decrypt a child node or may be used to verify a child node, for example. The counter tree can be trusted to identify modification of data based on the premise that the root node can be trusted (and this trust can be passed down the tree).

In some examples, the root node is protected by storing the root node in a trusted memory. In this way, an attacker may have no means to access the root node and therefore no means to modify the root node.

In some examples, the root node may be relatively large (compared to the amount of available trusted memory) and therefore it may be desirable to store the root node in less restricted non-trusted memory. In this case, the root node may be protected using a value stored in trusted memory. For example, an authentication code algorithm could be used to generate a root authentication code based on the root node. The root authentication code may be smaller than the root value itself. The root authentication code may then be stored in trusted memory such that it cannot be modified. The root node can then be verified by regenerating the root authentication code based on a retrieved root value and comparing it to the trusted stored root authentication code. If there is a match then it can be determined that the root node has not been modified and can be trusted.

In some examples, the trusted memory may be on-chip memory and the non-trusted (or less-trusted) memory may be off-chip memory.

In some examples, the two or more counter values are non-repeating counters, meaning that each time they are updated, the new value is a value that has not been previously taken by that counter. For example, the non-repeating counters may by monotonic counters which are only updated in one direction. A monotonic counter may only count up or may only count down, such that when a monotonic counter is updated the updated counter value is guaranteed to be a new, previously unseen, value. The use of non-repeating counters can be useful because the counter is used to prevent replay attacks, and if the counter repeats values then there is a possibility that an attacker could modify stored data by replacing the data with the data and MAC that were stored the last time the counter took the repeating value. Hence, requiring the counter values to be non-repeating counters improves the resistance against replay attacks.

Particular configurations of the present techniques will now be described with reference to the accompanying figures.

FIG. 1 schematically illustrates an example of a data processing system 2, which comprises an integrated circuit or system-on-chip 4 which includes at least one processor core 6 for executing program instructions to carry out data processing operations. While FIG. 1 only shows one processor core in some cases the system-on-chip 4 may comprise multiple processors. Each processor core or processor core cluster may have a cache 8 (or multiple levels of cache 8, 10). A memory controller 12 acts as memory access circuitry for controlling access to an off-chip memory 14 which is on a separate integrated circuit from the system-on-chip 4. While accesses to data on-chip may be difficult to tamper with by an attacker, the edge of the system-on-chip may act as a trust boundary and any data passing beyond that boundary may be vulnerable to attack by intercepting data on the physical channel 16 between the memory controller 12 and the off-chip memory 14, or by reading or modifying the data while it is stored in the off-chip memory 14. While FIG. 1 shows an example where the trust boundary corresponds to the edge of the system-on-chip, in other cases there could be trust boundaries within a system-on-chip which could expose data beyond the trust boundary to potential attacks.

The system-on-chip 4 may include a memory security unit 20 provided for protecting data 24 stored to the off-chip memory 14 from a malicious adversary who has physical access to the system and the ability to observe and/or replay the data or code being exchanged between the microprocessor and the off-chip system memory 14. The off-chip memory 14 may include data 24 to be protected as well as a counter tree 26 and message authentication codes (MACs) 28 used in the verification of the data 24. An unprotected memory region (not shown) may also be provided in the off-chip memory 14, and data stored in the unprotected region is not protected by the memory security unit 20 and so is free to be accessed and modified by an attacker. In some implementations, the mapping of addresses to the protected and unprotected memory regions 22, 28 may be fixed by the hardware, so that it is not possible for an operating system or other software executed by the processor core 6 to vary which addresses are mapped to the protected memory region 22 or unprotected memory region 28. Alternatively, if the software controlling the address mapping can be trusted, the address mapping controlling which addresses are mapped to the protected region or the unprotected region may be varied by the processor under control of software, and so the protected and unprotected regions need not always map to the same physical locations in the off-chip memory 14. In some implementations, there may not be any unprotected memory region 28 provided in the off-chip memory 14—in this case the entire off-chip memory could be considered the protected memory region 22.

The memory security unit 20 includes encryption/decryption circuitry 32 for encrypting data 24 being written to the off-chip memory 14 and decrypting data read back from the off-chip memory. This provides privacy by preventing a malicious observer from seeing in the clear the data being read from or stored onto the off-chip memory 14. Encryption keys used by the encryption and decryption may be stored within an on-chip memory (e.g., SRAM) 34 on the system-on-chip or within the memory security unit 20 itself. Any known technique may be used for the encryption and decryption, and any known approach for protecting the encryption keys can be used.

The memory security unit 20 also includes counter tree generation and verification circuitry 36, referred to in general as verification circuitry 36. The terms counter tree circuitry and integrity checking circuitry as used below may in general refer to a combination of the elements of the memory security unit 20 as required for performing a particular operation. The verification circuitry 36 is responsible for maintaining the counter tree 26 in the protected memory region. The counter tree may provide a number of pieces of information for verifying whether data currently stored in the off-chip memory 14 is still the same as when it was written. The checking of data integrity can for example be achieved using message authentication codes (MACs) which may be generated from the stored data using algorithms which make it computationally infeasible for an attacker to guess the authentication code associated with a particular data value by brute force when a secret key used to generate the authentication code is unknown. For example, Cipher-based Message Authentication Code (CMAC), Hash-based Message Authentication Code (HMAC), or encrypted universal hash function (UHF) algorithms could be used to generate a MAC. The authentication codes may be stored alongside the data 24 or in a separate data structure 28. The stored MAC for a data value is checked against a calculated MAC derived from the stored data using the same function used to generate the stored MAC, and if a mismatch is detected between the stored MAC and calculated MAC then this may indicate that the data has been tampered with.

However, providing MACs alone may not be sufficient to prevent all attacks. Another type of attack may be a replay attack where a malicious person with physical access to the system stores a legitimate combination of the encrypted data and the MAC which was observed previously on the bus and then replays these onto the bus later with an intent to corrupt data at a given memory location with stale values so as to compromise the operation of the system. Such replay attacks can be prevented using the counter tree 26, which may provide a tree structure of nodes where each leaf node of the tree provides a counter for verifying that one of the blocks of data 24 in the protected memory region 22 is valid and a parent node of a leaf node provides further data associated with the leaf node itself. It will be seen from the following that this further data may not be used to actually verify the integrity of the leaf node, but it nevertheless allows modification of the leaf node to be identified during data verification. Parent nodes may themselves be associated with data in further parent nodes of the tree, and this continues as the tree is traversed up to the root of the tree which may then provide the ultimate source of verification. Root verification data 38 stored in the on-chip memory 34 may be used to verify that the root of the tree is authentic, either by storing the root node of the tree itself on on-chip, or by storing other information which enables the root node stored in the protected memory region to be authenticated.

The memory security unit 20 may have address calculating circuitry 40 for calculating the addresses at which the nodes of the counter tree 26 required for checking particular data blocks are located in the protected memory region 22. Optionally, the memory security unit may also have a cache 42 for caching recently used nodes of the counter tree for faster access than if they have to be read again from the off-chip memory 14. Alternatively, the memory security unit 20 could have access to one of the caches 10 which may also be used by the processor core 6 and so caching of data from the counter tree 26 within the shared cache 10 could also help to speed up operation of the memory security unit 20.

In some techniques using a counter tree, a counter in one node of the tree may be used to verify the data in a child node, and so on down the tree. FIG. 2 shows an example of implementing such a tree. Each leaf node 84 may specify a number of counters for verifying the integrity of data 50. For each leaf node 84 of the tree a MAC 80 is computed based on the contents of the leaf node 84 and a counter 86 read from a non-leaf node 88 which acts as the parent node of the leaf node 84. Each non-leaf node 88 provides the counters used for multiple child nodes 84. Similarly, at each level of the tree, the counter 86 used to compute the MAC 80 for a given child node is read from a data block 88 corresponding to the parent node of that child node, all the way up to the root node 88-R. The address calculating circuitry 40 of the memory security unit 20 identifies, for a given target data block of interest, which other data blocks store the required nodes of the tree providing the relevant counters. Eventually, the root node 88-R is reached and the MAC 80 for the root node is computed as a function of the contents of the root node and a root counter 89. The root counter 89 could be stored as the root verification data 38 in the on-chip memory 34. Alternatively, the entire root node 88-R of the tree could be stored in the root verification data in the on-chip memory and in this case there is no need to compute a further MAC for this root node.

The counters stored in the leaf nodes 84 can be used for verifying data integrity. Each data block 50 of the protected memory region 22 which is not part of the integrity tree 26 itself is protected by a MAC 80, which is computed based on the contents of the data block 50 and a counter 82 which is read from a leaf node 84 of the counter integrity tree 26. The leaf node 84 may specify a number of counters each corresponding to different data blocks 50. In this example the MAC 80 calculated for a given data block 50 is stored adjacent to the corresponding data. This is not essential, and in other examples, the MAC could be stored separately from the corresponding data.

In summary, with the tree shown in FIG. 2, at each level of the tree the integrity of the counters of a given node is ensured by using a MAC stored in the node. However, it has been recognised that the storage of a MAC in each node of a tree may be undesirable due to the storage requirements of the MAC. In an example node having 64 bytes of storage, a MAC may occupy 64 bits, and therefore represent ⅛ of the total storage requirements of a tree. If the MAC could be removed, then the number of counters in a node of a given size could be increased. Increasing the number of counters in a node allows each node to be associated with more child nodes (increasing the arity of the tree). When more nodes are associated with each parent node, the overall number of levels in a tree can be reduced. This allows a traversal of the tree to require fewer memory accesses, reducing the amount of traffic associated with accessing a tree and reducing the time to traverse a tree. Alternatively, removing the MAC may allow the nodes to be reduced in size, such that for a given tree the overall storage requirements can be reduced. Both of these advantages can be achieved at the same time in certain cases, with the removal of a MAC both enabling trees to be made shorter and reducing the storage requirements of a tree.

In some examples of the present technique, a counter tree may be provided to protect the integrity of data stored in a memory without verifying the integrity of the counters stored in each node.

FIG. 3 schematically illustrates an example of an encryption operation. A string of data representing some values can be referred to as plaintext 100. This may, for example, be the data which one wishes to store in a node, and could comprise two or more counter values. An encryption operation 102 can be used to convert the plaintext 100 to an encrypted representation of the plaintext referred to as ciphertext 104. An observer reading the ciphertext 104 is not able to deduce the plaintext 100. This may be because the encryption operation depends on a secret key, and without access to the secret key the observer is unable to convert the ciphertext 104 to plaintext 100. The encryption operation 102 may have the property of diffusion, in which when two strings of plaintext differing in one bit are encrypted, the resulting strings of ciphertext differ (on average) in half of the bits. This means that patterns in the plaintext are not generally observable in the ciphertext and prevents an attacker from deducing information about the plaintext by observing the ciphertext. If the plaintext comprises a number of counters, for example, in which an incremented counter has mostly the same bits as the previous counter value, this will not be evident in the ciphertext when the encryption operation has the property of diffusion.

The encryption operation may take further values 108 as inputs, such as a secret key and an address corresponding to the data to be encrypted (such as the address of a node).

The encryption operation shown in FIG. 3 may be used to encrypt the counter values stored in a leaf node of a counter tree. In this case, the encryption operation may also take as an input the value of a parent counter 106 stored in the parent node of the leaf node. Therefore, the relationship between plaintext 100 and ciphertext 104 for the leaf node depends on the value stored in the parent node. If a value other than the correct parent counter value were used to decrypt the leaf node, the result of the decryption may not equal the plaintext that was originally stored to the leaf node. If the encryption operation has the property of diffusion, the resultant plaintext will essentially be random noise when the incorrect parent counter value is used to decrypt the ciphertext retrieved from the leaf node. Likewise, if the ciphertext stored in the leaf node is modified then the plaintext resulting from the decryption operation will not be the same as the plaintext stored to the leaf node, and if the encryption operation has the property of diffusion then the resulting plaintext will effectively appear to be random noise. Hence, modifying either the parent counter value or the ciphertext of a leaf node causes the incorrect plaintext to be retrieved from the node.

One might think that, because the leaf nodes are not integrity checked, then if the counter value stored in the leaf node were replaced by a counter that matched a previous set of data and MAC, then an attacker could modify data stored in the memory and the counter tree to cause old data to pass the integrity check. However, this is not true because although not checked for integrity, the counter stored in the leaf node is encrypted in a way which depends on a further value in a higher-level node (the first node). The parent counter value stored in the first node may be incremented every time new data is stored to its child leaf node. The attack described above involves replacing ciphertext of the leaf node with previous ciphertext. However, when the previous ciphertext is decrypted to generate plaintext including counters to be used in data verification, the integrity checking circuitry will use the updated parent counter value. Hence, a parent counter value that does not correspond to the modified ciphertext will be used in the decryption operation. Therefore, the decryption operation will not produce plaintext including the previous counter value, but will rather produce completely meaningless plaintext that is essentially noise. The decrypted ciphertext does not therefore include a previous counter value and cannot be used in a replay attack.

The above technique may appear to rely on the parent counter value being trusted. In some examples, this could be ensured by performing integrity checking on the parent counter value (eventually being based on a trusted root node). However, in other examples the parent node of the leaf node may not be subject to integrity verification. Rather, the parent node may also be encrypted in an operation depending on a value stored in a further node. The parent counter value cannot be replaced with previously valid parent counter ciphertext because when decrypted using a value from a further higher-level node, the previously valid ciphertext will be decrypted to produce incorrect plaintext. This argument can be applied recursively up the tree until a parent value is reached which may be trusted (the root node or a node subject to integrity verification based on the root node).

In summary, resistance against replay attacks can be provided by encrypting a node of a counter tree based on a counter stored in a parent node. An attacker cannot replace the counters in the tree with previously valid values corresponding to some modified item of data because the counters in the tree are decrypted based on a protected counter (e.g., in the root node) which cannot be modified without this being detected. Previously valid ciphertext stored by an attacker at any unprotected node of the tree will not be decrypted correctly because it is decrypted in dependence on a protected value which is expected to have changed since the ciphertext was previously valid. Hence, the proposed counter tree prevents replay attacks. In addition, the proposed counter tree prevents replay attacks without requiring verification of nodes of the tree other than the root node. Hence, the proposed counter tree does not need to provide MACs in each node, which can significantly reduce the storage requirements of a counter tree or increase the arity of a counter tree.

FIG. 4 is a schematic illustration of a counter tree in which each node of the tree other than a root node is encrypted based on a value in a parent node. A root value 110 may be stored in trusted memory or may be protected using a value stored in trusted memory. The root value 110 may be used to encrypt data to be stored in a node 112 of the counter tree in an encryption operation 102 such as that shown in FIG. 3. The plaintext 100 of the node 112 comprises two or more counter values, each corresponding to one child node 114. It will be appreciated that whilst the ciphertext 104 is the data which is actually stored to memory, it can be useful to think of storing the plaintext 100 in nodes. Each counter value is used to encrypt the corresponding child node 114 in an encryption operation 102. In the tree shown in FIG. 4, the node 114 may be referred to as the first node. The first node contains two or more parent counter values, each of which is used to encrypt a child node 116. The node 116 may be referred to as the second node, or a leaf node. The leaf node contains two or more counter values, each corresponding to an item of data 50. A counter value stored in the leaf node is used in the generation of a MAC 80 for the corresponding item of data for data integrity checking. The function 54 for generating a MAC 80 based on an item of data 50 and a counter may be substantially the same as that shown in FIG. 2.

If an attacker wishes to perform a replay attack, they may replace the item of data 50 and stored MAC 80 with previously valid MAC and data (i.e., data and MAC values that have been previously observed on the bus or read from the non-trusted memory). However, because the MAC 80 is generated based on the data and the counter value, then for the previously valid MAC to still be valid the counter value would also need to be replaced with a previous counter value. The counter value is encrypted using a parent counter so if the attacker were to simply replace the ciphertext of the counter value with the ciphertext of the previous counter value which corresponds to the replayed data/MAC combination, this would still not work as it would be decrypted incorrectly producing incorrect plaintext. The attacker could attempt to also replace the parent counter value with a previously valid parent counter value, but doing so would lead to the same problem because that is itself encrypted using a further value which is expected to have changed (or is simply subject to integrity checking). This argument applies further up the tree until a level is reached that can be trusted. Hence, the integrity of an item of data in non-trusted memory can be protected in a way that is resistant to replay attacks because counters used in the integrity checking process are encrypted based on values in a higher level of the tree. This technique avoids the need to check the integrity of every node in the tree, and is therefore associated with lower overhead when traversing the tree (because node verification operations do not need to be performed) as well as allowing MACs to be removed from nodes of the tree.

A particularly effective method of storing counters in a node is to represent a given counter as a combination of a major counter 120 and a minor counter 122. The major counter 120 could store the most significant bits and the minor counter 122 could store the least significant bits, for example. By splitting counters in this way, multiple minor counters 122 may be associated with a single major counter 120, and therefore the average number of bits required to represent each counter can be reduced without reducing the number of bits in each counter. For example, rather than providing 10 72-bit counters, a 64-bit major counter and 10 8-bit minor counters could be provided. Each counter has the same number of bits (72), but it takes on average just over 14 bits to represent each split counter instead of 72 bits for individual counters. FIG. 5 shows an example node including split counters including a major counter 120 and two or more minor counters 122.

Certain encryption algorithms (known as block ciphers) operate at a fixed block size, meaning that the number of bits of plaintext that can be encrypted in one iteration of the encryption algorithm may be fixed. For example, the AES block cipher can encrypt 128 bits of plaintext to produce 128 bits of ciphertext in one iteration. Encryption blocks may be encrypted and decrypted independently from each other. If any bits of a block are modified the entire block may be completely changed after decryption (such as if the encryption operation has the property of diffusion). If an item of plaintext is to be encrypted using a block cipher when the block size is smaller than the size of the item of data, the item of data may be separated into sections and each section may be encrypted separately. FIG. 5 shows an example node separated into blocks B₀, B₁, and B₂, wherein each block takes the block size of a selected encryption algorithm (e.g., 128 bits). A block containing a major counter (B₀) may be referred to as a major block. The major block may contain a number of minor counters in addition to the major counter. Blocks containing no major counter (e.g., B₁) may be referred to as minor blocks. It will be appreciated that the number of minor counters shown per block is not limiting, and is merely for illustration. If 8-bit minor counters were used for 128-bit blocks, each minor block may contain 16 minor counters, for example.

A counter may be incremented (or, equivalently, decremented) each time data is stored to memory. When the counter is incremented, the most significant bits corresponding to the major block may not be updated, and only the minor bits may be updated. Hence, the plaintext between successive counter values may differ only in the minor counter values. In a replay attack, an attacker may wish to roll-back the counter to a previous value when replacing the stored data with previous data. Since the previous counter value was stored, a parent counter may have been updated meaning that the counter is encrypted in a different way to previously, so the attacker cannot use the previous counter ciphertext value. To update the counter to get a correct value they may only be able to randomly guess and hope that the randomly guessed ciphertext is decrypted to provide the previous counter value, allowing the modified data to pass the integrity check. However, if the attacker can assume that the bits in the major counter are the same as the previous counter value then these bits may not need to be guessed. Because the major counter may be in a different block to the minor counter of interest, the block containing the major counter can be completely left alone, meaning it will be correctly decrypted (although the plaintext of these bits may be the same as the previous counter value, the ciphertext will differ). Hence, when the counters are represented as split counters an attacker may only need to correctly guess the bits in the minor counters. The attacker has a much higher chance of randomly guessing the minor counter values because the minor counters are much smaller than the whole counter. For example, with 72-bit counters, an attacker has a 2\hat{ }{−72} chance of success at guessing the entire counter but with split counters having 64-bit major counters and 8-bit minor counters, the attacker may have a 2\hat{ }{−8} chance of randomly guessing the minor counter bits.

However, there are several techniques for reducing the probability of a successful attack when using split counters in an encrypted node.

In one example, the node could simply be made small enough to fit within one encryption block. In FIG. 5, this may be equivalent to restricting the node to the size of block B₀. Restricting the minor and major counters to the same block means that minor counters cannot be modified without affecting the major counter, because modifying any bits of the ciphertext block will completely change the plaintext values of the entire block. With a 128-bit block, and 64-bit major counter, this may limit each node to storing 8 8-bit minor counters and therefore having 8 child nodes or associated items of data. This may be acceptable in some cases, but could lead to the tree requiring more levels to represent the same number of counters.

In another example, the block-size could be increased to the size of an entire node. This is a similar technique to that described above, preventing minor counters being modified independently from the major counter. However, it differs from the above technique because rather than reducing the node size to the block size of a conventional encryption operation, the block size is increased beyond that of conventional encryption algorithms. This technique may use one of several wide-block encryption techniques to achieve the increased block size. This technique allows larger nodes to be used, increasing the arity of the tree, whilst avoiding the vulnerability of the use of split counters. However, there may be a high overhead associated with wide-block encryption which could make this method less desirable in some cases.

In yet another example, the major block may be encrypted in an operation which takes the minor blocks as an input. When decrypting the node, the decryption of the major block will therefore depend on the minor blocks. If any of the minor blocks have been modified by an attacker, then the major block will be decrypted differently. This means that an attacker is unable to modify the minor blocks without changing the decrypted value of the major counter. This allows the size of nodes to be maintained and avoids the use of high-overhead wide-block encryption, providing advantages over the two techniques described above.

Using any of the above techniques an attacker is unable to modify only the minor counters and any guess of the counter needs to match all of the counter values, reducing the probability of a successful attack to the same as if the counters were provided separately.

FIG. 6 is a flow diagram illustrating a method of using a counter tree to protect the integrity of an item of data stored in a non-trusted memory. At step 600, a parent counter value is retrieved from a parent node. The value retrieved at step 600 is trusted, and may be trusted due to: being a value stored in on-chip memory, being integrity checked using a value stored in on-chip memory, or being integrity checked using an integrity tree based on a value stored in trusted memory. The trusted parent counter value can be trusted not to have been modified, because either it was not possible for an attacker to access the value or because modification would have been identified in an integrity check.

At step 602 the trusted parent counter is used to decrypt a child node. The child node selected is the child node on the path to the item of data of interest. The decryption operation takes as an input the ciphertext stored in the child node, the parent counter value, and possible other values such as a secret key and an address of the child node.

At step 604 it is determined whether the child node that was decrypted at step 602 is a leaf node.

If not, then the method proceeds to step 606. Here, the previously decrypted child node must also be the parent node of further child nodes because it is not a leaf node. Therefore, this node is used to decrypt a further child node. From the decrypted plaintext calculated in step 602, a counter corresponding to a new child node is selected. The new child node is the child node on the path to the item of data of interest. The counter is selected by selecting bits of the plaintext at bit positions corresponding to the selected child node. The selected counter can be considered to be the new parent counter. After step 606, the process returns to step 602 and the new parent counter is used to decrypt the new child node. This process may repeat down the tree, with the node at each level being used to decrypt a child node on the path to the item of data until the leaf node is reached.

When it is determined at step 604 that the previously decrypted node was a leaf node, the process proceeds to step 608. Here, the counters in the leaf node are used to verify the integrity of data (as opposed to the counters in higher-level nodes which are used to encrypt lower level nodes in a way which changes each time the counter is updated). To verify a given item of data, a counter is selected from the decrypted leaf node.

At step 610, a MAC is generated based on the counter selected at step 608 and the item of data retrieved from the memory. At step 612 the MAC generated at step 610 is compared against a stored MAC. The stored MAC was generated when the item of data was stored to memory, based on the item of data and the relevant leaf node counter at that time. The item of data and the relevant leaf node counter should not have changed (unless there has been an attack) therefore the stored MAC and generated MAC should match. If they do match, then at step 614 it is determined that the integrity of the data can be verified.

If they do not match, then at step 616 it is determined that the integrity of the data cannot be verified. This may mean that the data has been modified and/or that any of the counters in the tree have been modified.

It is noted that the decryption (step 602) at any level of the tree may not produce “correct” plaintext. If the inputs to any decryption operation have been modified then the plaintext that is produced by performing the decryption operation on the retrieved ciphertext will not be the plaintext that was used to generate the ciphertext in an encryption operation. A counter may still be selected from the incorrect plaintext and used to decrypt the next level of the tree. However, the selected “counter” will effectively be random bit values, not corresponding to the counter that would be used if the ciphertext were decrypted correctly, and it will mean that the next level of the tree is also decrypted incorrectly.

FIG. 7 is a flow diagram illustrating a method of storing an item of data protected by a counter tree to memory. A selected leaf node is the leaf node corresponding to the item of data to be protected. At step 700 the nodes on the path from the root node to the selected leaf node are decrypted (for example as in the steps 600-608).

At step 702 the counter corresponding to the item of data in the leaf node is incremented. Incrementing the leaf node counter each time an item of data is stored to memory makes replay attacks more difficult and an attacker may be unable to replace the item of data and its corresponding MAC with a previous pair of data and MAC values. Counters may be made sufficiently large so that even if the data is updated (and the counter is therefore incremented) very regularly, the counter is not expected to overflow in a reasonable amount of time (such as until the data processing system is reset). Alternatively, mechanisms may be used by which counters can be reset.

At step 704, a MAC is generated based on the item of data to be stored to memory and the incremented counter value. The MAC function may take as an input further values such as a secret key and the address of the item of data to be protected. The generated MAC and the item of data can then be stored to memory, either separately or together.

At step 706, the counter corresponding to the leaf node in its parent node is incremented. At step 708, the incremented parent counter value is used to encrypt the leaf node. Hence, the counter in the leaf node is encrypted in a way which changes each time the item of data is updated. This prevents the counter from being replaced with a previous counter value in a replay attack, because the counter would be decrypted differently and therefore the same ciphertext counter would lead to a different plaintext counter.

At step 710 it is determined whether the parent node is a trusted node, such as a protected root node. If so, then the counter tree update is complete at step 714, because the parent node being trusted means that the parent counter value can be trusted and relied on for the integrity of the item of data. However, if the parent node is not trusted then the parent counter value could also be replaced with a previous version (which might cause a previous counter value to be correctly decrypted).

If the parent node is not trusted then the update and encryption process continues further up the tree. At step 712 the previous parent node can be considered to be the new child node and the process returns to step 706. That is, the counter value in the parent node of the previous parent node is updated and used to encrypt the previous parent node. It will be appreciated that the order of the steps may not necessarily be the same as shown in FIG. 7. For example, each counter on the path from the leaf node to a trusted node may be incremented first and only after each counter has been incremented may the counters be used to encrypt a child node. It will also be appreciated that certain steps may take place in parallel.

FIG. 8 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software-based implementation of a hardware architecture. Varieties of simulator computer programs include emulators, virtual machines, models, and binary translators, including dynamic binary translators. Typically, a simulator implementation may run on a host processor 800, optionally running a host operating system 805, supporting the simulator program 810. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 800), some simulated embodiments may make use of the host hardware, where suitable.

The simulator program 810 may be stored on a computer-readable storage medium (which may be a non-transitory medium), and provides a program interface (instruction execution environment) to the target code 815 (which may include applications, operating systems and a hypervisor) which is the same as the interface of the hardware architecture being modelled by the simulator program 810. Thus, the program instructions of the target code 815 may be executed from within the instruction execution environment using the simulator program 810, so that a host computer 800 which does not actually have the hardware features of the apparatus discussed above can emulate these features. The simulator program 810 may have counter tree program logic 820 which emulates the functionality of the counter tree circuitry 20, and integrity checking program logic which emulates the functionality of the integrity checking circuitry 36, as described above.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
counter tree circuitry configured to maintain a counter tree comprising a plurality of nodes;
wherein the counter tree circuitry is configured to store:
in a first node of the counter tree, a representation of a parent counter value; and
in a second node of the counter tree, wherein the second node is a child node of the first node, an encrypted representation of two or more counter values, wherein an encryption operation for forming the encrypted representation of the two or more counter values takes as an input the parent counter value; and
integrity checking circuitry configured to check the integrity of an item of data retrieved from memory based on a comparison between a stored authentication code and a generated authentication code generated based on the item of data and a decrypted counter value, the decrypted counter value being determined from a corresponding retrieved encrypted representation of a counter value retrieved from the second node,
wherein the retrieved encrypted representation of the counter value is decrypted using a retrieved parent counter value retrieved from the first node.

2. The apparatus according to claim 1, wherein
a decrypted representation of the two or more counter values comprises:
a major counter shared between the two or more counter values; and
two or more minor counters, wherein a given minor counter corresponds to a given counter value of the two or more counter values;
wherein the given counter value of the two or more counter values is equal to a combination of the major counter and the given minor counter.

3. The apparatus according to claim 2, wherein
the encryption operation for forming the encrypted representation of the two or more counter values is a full-node encryption operation which encrypts all of the two or more counters in a single encryption block.

4. The apparatus according to claim 3, wherein
the encryption operation is a wide-block encryption operation.

5. The apparatus according to claim 2, wherein
the decrypted representation of the two or more counter values comprises two or more blocks;
a major block is a block comprising the major counter; and
the encryption operation for forming the encrypted representation of the two or more counter values encrypts the major block based on the two or more minor counters.

6. The apparatus according to claim 5, wherein
the two or more blocks comprise blocks B-0 and B-1 to BN, wherein block B0 is the major block, and blocks B₁ to B_{N} are minor blocks comprising minor counters and no major counter;
the value X is given by X=H(A∥CP∥B1∥ . . . ∥BN), wherein H is a universal hash function, A is an address corresponding to the first node, CP is the parent counter value, and ∥ is the concatenation operation; and
the encrypted representation of block B0 is D0=E(X⊕B0)⊕X, wherein E is an encryption operation, and ⊕ is the XOR operation.

7. The apparatus according to claim 1, wherein
the encryption operation for forming the encrypted representation of the two or more counter values takes as an input an index of the second node.

8. The apparatus according to claim 7, wherein
the index is derived from the memory address of the second node.

9. The apparatus according to claim 1, wherein
the first node and the second node are stored in non-trusted memory; and
the integrity of the parent counter value retrieved from the first node is protected using a root value associated with a root node.

10. The apparatus according to claim 1, wherein
the first node and the second node are stored in non-trusted memory; and
the counter tree circuitry is configured to store, in the first node, an encrypted representation of the parent counter value, wherein a second encryption operation for forming the encrypted representation of the parent counter value takes as an input a further counter value associated with a further node which is a parent node of the first node.

11. The apparatus according to claim 10, wherein
the integrity checking circuitry is configured to decrypt the encrypted representation of the parent counter value using a retrieved further counter value retrieved from the further node.

12. The apparatus according to claim 11, wherein
each node between the second node and a root node comprises an encrypted counter value encrypted in an encryption operation taking as an input a value of a parent counter, wherein a representation of the parent counter is stored in the parent node of said node.

13. The apparatus according to claim 1, wherein
there is no message authentication code stored in the second node of the counter tree.

14. The apparatus according to claim 13, wherein
there are no message authentication codes stored in any node of the counter tree.

15. The apparatus according to claim 1, wherein
the parent counter value is updated each time a counter value of the two or more counter values is updated.

16. The apparatus according to claim 1, wherein
the generated authentication code is generated based on one or more of:
a secret key; and
an index of a memory location at which the item of data is stored.

17. The apparatus according to claim 1, wherein a protected root node is stored in one of:
a trusted memory; and
the non-trusted memory and is protected using a value stored in trusted memory.

18. The apparatus according to claim 1, wherein the two or more counter values are non-repeating counter values.

19. A method of operating a data processing apparatus to maintain integrity of data, comprising:
maintaining a counter tree comprising a plurality of nodes;
storing, in a first node of the counter tree, a representation of a parent counter value;
storing, in a second node of the counter tree, wherein the second node is a child node of the first node, an encrypted representation of two or more counter values, wherein an encryption operation for forming the encrypted representation of the two or more counter values takes as an input the parent counter value; and
checking the integrity of an item of data retrieved from memory based on a comparison between a stored authentication code and a generated authentication code generated based on the item of data and a decrypted counter value, the decrypted counter value being determined from a corresponding retrieved encrypted representation of a counter value retrieved from the second node,
wherein the retrieved encrypted representation of the counter value is decrypted using a retrieved parent counter value retrieved from the first node.

20. A computer program for controlling a host data processing apparatus to provide an instruction execution environment, comprising:
counter tree program logic to maintain a counter tree comprising a plurality of nodes;
wherein the counter tree program logic is arranged to store:
in a first node of the counter tree, a representation of a parent counter value; and
in a second node of the counter tree, wherein the second node is a child node of the first node, an encrypted representation of two or more counter values, wherein an encryption operation for forming the encrypted representation of the two or more counter values takes as an input the parent counter value; and
integrity checking program logic to check the integrity of an item of data retrieved from memory based on a comparison between a stored authentication code and a generated authentication code generated based on the item of data and a decrypted counter value, the decrypted counter value being determined from a corresponding retrieved encrypted representation of a counter value retrieved from the second node,
wherein the retrieved encrypted representation of the counter value is decrypted using a retrieved parent counter value retrieved from the first node.
